(19) United States
(12) Patent Application Publication
(10) Pub. No.: US 2003/0076236 A1
(43) Pub. Date: Apr. 24, 2003

(54) Device and method for broadband RF detection

(76) Inventors: Heston Cooksey, Elliston, VA (US); Carl Herman Tickle SR., Roanoke, VA (US)

Correspondence Address: Michael N. Haynes, 1341 Huntersfield Close, Keswick, VA, 22947, US

(21) Appl. No.: 10/273,928

(22) Filed: Oct. 18, 2002

Related U.S. Application Data
(60) Provisional application No. 60/348,719, filed on Oct. 22, 2001.

(51) Int. Cl. G08B 21/00; H04B 7/24

(52) U.S. Cl. 340/686.6; 455/39; 361/600; 340/539; 340/693.5

(57) ABSTRACT

At least one exemplary embodiment of the present invention comprises a system comprising an antenna capable of receiving radiated energy within a frequency range of approximately 1 MHz to approximately 3 GHz, a broadband amplifier circuit electrically coupled to said antenna, a power source electrically connected to said broadband amplifier circuit; and an indicator electrically connected to said broadband amplifier circuit. At least one exemplary embodiment of the present invention comprises a method comprising receiving, from a radiating device, radiated energy within a frequency range of approximately 1 MHz to approximately 3 GHz at a detection device having an antenna electrically connected to a powered broadband amplifier circuit that is electrically connected to an illuminable indicator, the antenna, circuit, and indicator contained in a watertight enclosure; and illuminating the illuminable indicator if a voltage created across the antenna by the received radiated energy is above a predetermined amount. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims. 37 CFR 1.72(b).

### CROSS-REFERENCE TO RELATED APPLICATIONS

This application claims priority to, and incorporates by reference herein in its entirety, the following pending provisional application:

Serial No. 60/348,719 filed Oct. 22, 2001.

### BRIEF DESCRIPTION OF THE DRAWINGS

The invention and its wide variety of potential embodiments will be readily understood via the following detailed description of certain exemplary embodiments, with reference to the accompanying drawings in which:

FIG. 1 is a perspective view of an exemplary embodiment of a system 1000 of the present invention;

FIG. 2 is a side view of an exemplary embodiment of a system 2000 of the present invention;

FIG. 3 is a side view of an exemplary embodiment of a system 3000 of the present invention;

FIG. 4 is a circuit diagram of an exemplary embodiment of a system 4000 of the present invention;

FIG. 5 is a flowchart of an exemplary embodiment of a method 5000 of the present invention.

### DETAILED DESCRIPTION

At least one exemplary embodiment of the present invention comprises a system comprising an antenna capable of receiving radiated energy within a frequency range of approximately 1 MHz to approximately 3 GHz, a broadband amplifier circuit electrically coupled to said antenna, a power source electrically connected to said broadband amplifier circuit; and an indicator electrically connected to said broadband amplifier circuit.

At least one exemplary embodiment of the present invention comprises a device comprising a broadband radiated RF energy detector.

At least one exemplary embodiment of the present invention comprises a method comprising receiving, from a radiating device, radiated energy within a frequency range of approximately 1 MHz to approximately 3 GHz at a detection device having an antenna electrically connected to a powered broadband amplifier circuit that is electrically connected to an illuminable indicator, the antenna, circuit, and indicator contained in a watertight enclosure; and illuminating the illuminable indicator if a voltage created across the antenna by the received radiated energy is above a predetermined amount.

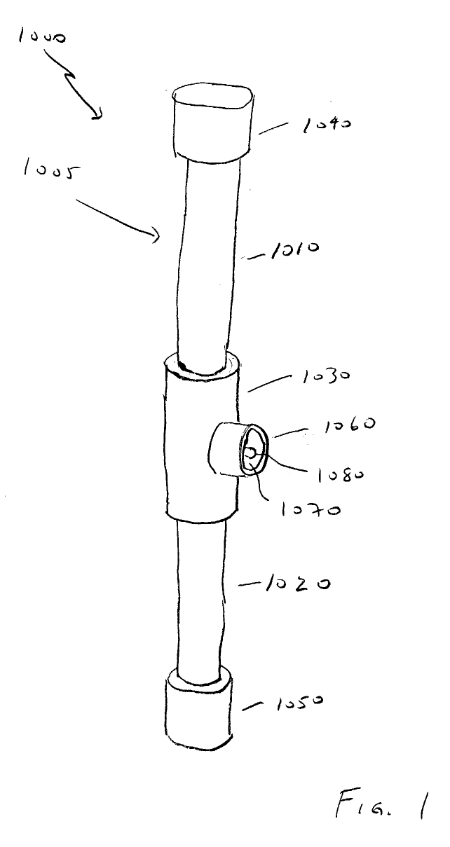

FIG. 1 is a perspective view of an exemplary embodiment of a system 1000 of the present invention. System 1000 can comprise a substantially tubular enclosure 1005, such as a watertight, chemical resistant, lightweight, convenient, heldheld, durable, and/or shock resistant enclosure, for a radio frequency presence and/or power indication circuit (not shown). System 1000 can comprise two tubular sections 1010, 1020, each having two axially opposed ends, one of which is sealed by a cap 1040, 1050, and another of which is joined by a connector 1030, such as a T-shaped connector. Connector 1030 can have an opening 1060, which can surround an illuminable indicator 1080, such as a bright, red LED. Between indicator 1080 and opening 1060 can be a transparent or translucent material, such as a polished quick-setting epoxy resin, that can serve to disperse light illuminated by indicator 1080.

Any of sections 1010, 1020, caps 1040, 1050, or connector 1030 can be formed of any substantially non-conductive material that can be assembled to form a watertight enclosure 1005. In one exemplary embodiment, sections 1010, 1020, caps 1040, 1050, and connector 1030 are formed of 0.5 inch PVC “pipe”, such as can be found in the plumbing section of a home improvement center. In one exemplary embodiment, sections 1010, 1020, are formed of 0.5 inch PVC pipe cut to 5.5 inches long. The PVC components can be assembled using CPVC cement.

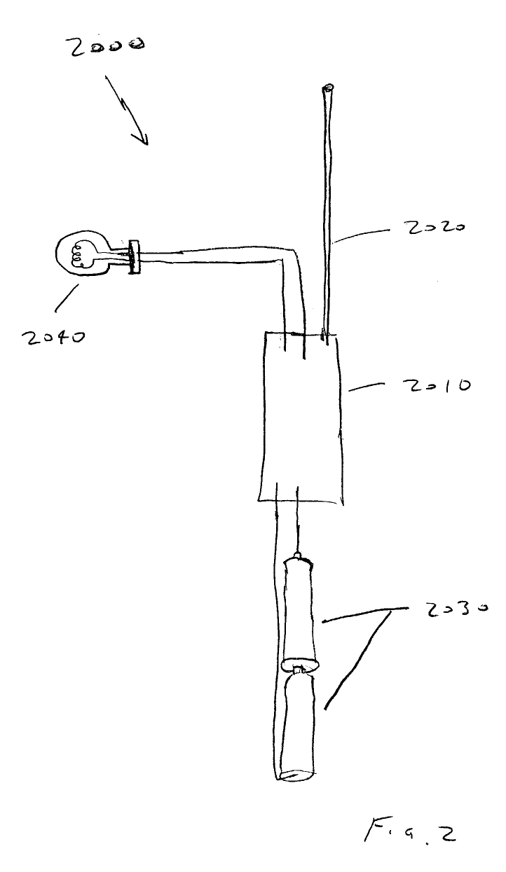

FIG. 2 is a side view of an exemplary embodiment of a system 2000 of the present invention. System 2000 can comprise a radio frequency presence and/or power indication circuit. System 2000 can comprise a circuit board 2010 that is electrically connected to an antenna 2020, such as a #20 gage solid copper wire. System 2000 can comprise a power source 2030, such as one or more batteries, such as two 1.5 volt AAA alkaline batteries. System 2000 also can comprise an illuminable indicator 2040, such as a lamp or LED.

System 2000 can be inserted, provided, and/or contained substantially within system 1000 to form a watertight, chemical resistant, lightweight, convenient, heldheld, durable, and/or shock resistant radio frequency presence and/or power detector. Circuit board 2010 and power source 2030 can be substantially contained within one tubular section, such as 1020, of system 1000. Antenna 2020 can be substantially contained within another tubular section, such as 1010, of system 1000. Indicator 2040 can be substantially contained within connector 1030 of system 1000. Indicator 2040 can be substantially surrounded by a relatively clear epoxy resin, which can diffuse the brilliance of indictor 2040 to give a wider visibility of the illumination of indicator 2040 to the viewer.

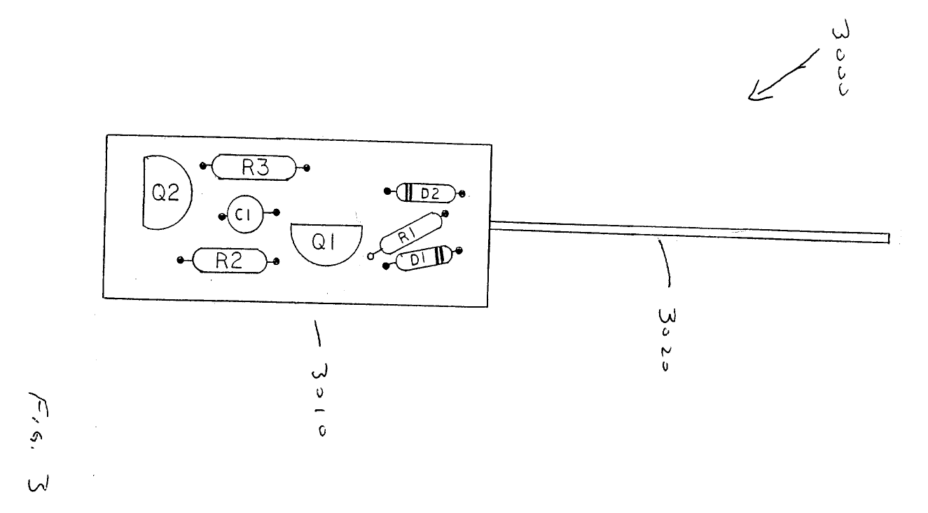

FIG. 3 is a side view of an exemplary embodiment of a system 3000 of the present invention, which can comprise a radio frequency presence and/or power indication circuit. System 3000 can include a circuit board 3010 comprising a double-sided etched and drilled epoxy/glass printed circuit board having a number of electronic components mounted thereto. Circuit board 3010 can be custom manufactured, such as by Digi-Key of Thief River Falls, Minn. Circuit board 3010 can be electrically connected to an antenna 3020. An exemplary embodiment of circuit board 3010 can be 1.0 inches long by 0.4 inches wide. An exemplary embodiment of antenna 3020 can be capable of receiving, and/or tuned to receive, a signal within a frequency range of approximately 1 MHz to approximately 3 GHz. An exemplary embodiment of antenna 3020 can be approximately 6.5 inches in length. This length roughly corresponds to the quarter-wavelength of a 450 MHz signal.

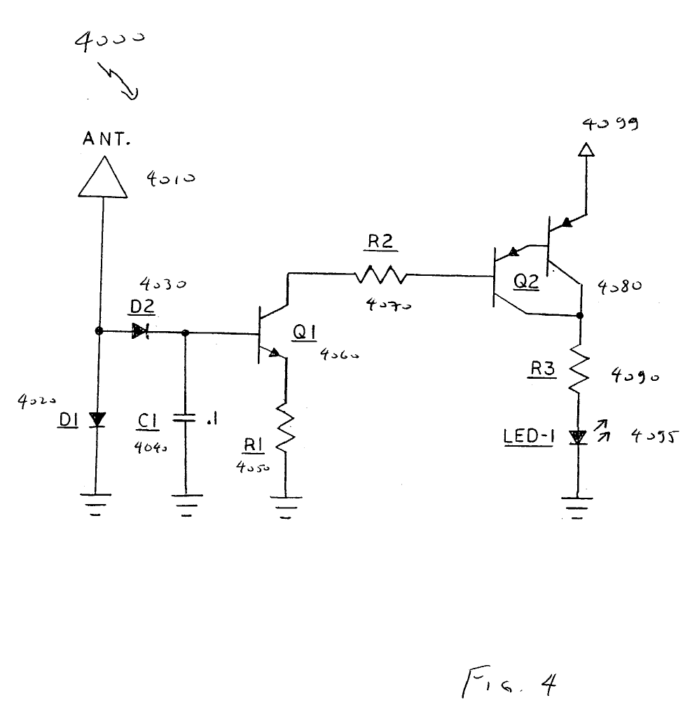

FIG. 4 is a circuit diagram of an exemplary embodiment of a system 4000 of the present invention, which can comprise a radio frequency presence and/or power indication circuit. System 4000 can include an antenna 4010 that can be connected in parallel to ground by a diode 4020 (D1) and to a diode 4030 (D2), which can be connected in parallel to ground by a capacitor 4040 (C1) and to the base of an NPN transistor 4060 (Q1). The emitter of transistor 4060 can be connected to ground via a feedback resistor 4050 (R1), and the collector of transmitter 4060 can be connected via a limit resistor 4070 (R2) to the base of a high gain switch (transistor) 4080 (Q2). Connected to the emitter of transistor 4080 can be a power source, such as a 3 volt power source. Connected to the collector of transistor 4080 can be a resistor 4090 (R3), which can be connected to ground via an indicator 4095 (LED-1).

In an exemplary embodiment, diodes 4020 and 4030 can be 1N34 germanium diodes. In an exemplary embodiment, transistor 4060 can be an 2N222A NPN transistor, and transistor 4080 can be a MP8A66 PNP Darlington transistor. In an exemplary embodiment, resistors 4050, 4070, and 4090 can be 1/4 W 1% resistors having resistances of 47, 27, and 180 ohms, respectively. In an exemplary embodiment, capacitor 4040 can be a 50WV 5% 0.1 microFarad capacitor. Any of these components of circuit 4000 can be purchased from a local retail store of Radio Shack, which is headquartered in Fort Worth, Tex., and/or from the Radio Shack catalog.

Note that diodes 4020 and 4030 can serve to provide full-wave rectification of a sinusoidal signal received at antenna 4010, and capacitor 4040 can serve to “smooth” or convert most of the rectified signal into essentially a DC voltage at the base of transistor 4060.

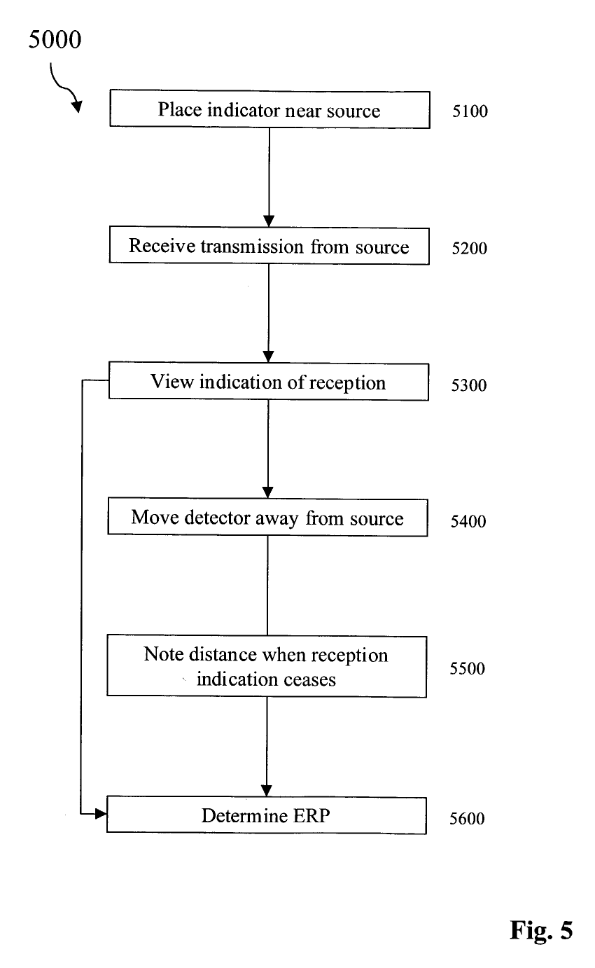

FIG. 5 is a flowchart of an exemplary embodiment of a method 5000 of the present invention. In certain embodiments, method 5000 can be utilized in conjunction with any of systems 1000, 2000, 3000, and/or 4000. At activity 5100, a radio frequency presence and/or power detector can be placed near a potential source of radiated radio frequency energy. In this context, “near” is defined to mean within, for example, 200 feet, 100 feet, 50 feet, 25 feet, 10 feet, 5 feet, 4 feet, 3 feet, 2 feet, and/or 1 foot, but typically not directly touching. The potential source can be, for example, a radiating antenna, a radio transmitter, a walkie-talkie, a cordless phone, a cellular phone, a microwave oven, an electric fence, an electrical transmission line, and/or a spark plug.

At activity 5200, a radiation and/or transmission of a radio frequency signal can be received from the source at an antenna of the detector. The received signal can be broadband, that is, can contain any number of frequency components and any power spectral density. If a frequency component of the signal received at the antenna is of sufficient power and within a frequency range of approximately 1 MHz to approximately 3 GHz, or within a range of approximately 1 MHz to approximately 2 GHz, or within a range of approximately 1 MHz to approximately 1 GHz, or within a range of approximately 1 GHz to approximately 2 GHz, a voltage can be created across the antenna 4010 of FIG. 4 of the detector.

By virtue of at least a portion of system 4000, if a resulting voltage at the base of transistor 4060 of FIG. 4 is sufficient, (e.g., approximately 450 mVDC to 550 mVDC in one exemplary embodiment of the invention), indicator 4095 of the detector can be illuminated. Such a voltage at the base of transistor 4060 can arise when the voltage created across antenna 4010 is greater than a predetermined amount, such as for example, at least approximately: 25, 50, 100, 150, 200, 225, 250, 300, 350, 400, 450, and/or 500 millivolts.

Because indicator 4095 can illuminate when a signal having sufficient power is received at antenna 4010 regardless of the frequency spectrum of the signal (so long as a sufficient portion of the signal's frequency spectrum is within a relatively broad range of frequencies), the detector can be considered to be a “broadband” radio frequency radiation detector. That is, the detectable bandwidth of the signal is relatively broad, being within a frequency range of approximately 1 MHz to approximately 3 GHz, or within a range of approximately 1 MHz to approximately 2 GHz, or within a range of approximately 1 MHz to approximately 1 GHz, or within a range of approximately 1 GHz to approximately 2 GHz. In other words, the detector is not sharply tuned to a specific frequency.

At activity 5300, a user of the detector can view the illuminator. If little or no illumination is present, at activity 5600 the user can conclude that the transmission is absent, contains no frequency components in the detectable range of the detector, and/or contains no frequency components in the detectable range of the detector having sufficient power to drive illumination of the indicator. Such a conclusion can suggest that either the transmitter or its antenna are faulty.

Assuming the illuminator is illuminated, at activity 5400 the detector can be moved away from the transmission source, for instance, by an increment of less than approximately: 100 feet, 50 feet, 20 feet, 10 feet, 5 feet, 4 feet, 3 feet, 2 feet, 1 foot, 6 inches, and/or 3 inches. At activity 5500, the user can note the distance between the transmitter and the antenna of the detector at which the illumination ceases. At activity 5600, the user can multiply the noted distance by 2 to determine the approximate Effective Radiated Power (ERP) of the transmission. If the determined ERP substantially varies from an expected ERP, this can suggest to the user that either the transmitter and/or its antenna is faulty.

Although the invention has been described with reference to specific embodiments thereof, it will be understood that numerous variations, modifications and additional embodiments are possible, and accordingly, all such variations, modifications, and embodiments are to be regarded as being within the spirit and scope of the invention. Also, references specifically identified and discussed herein are incorporated by reference as if fully set forth herein. Accordingly, the drawings and descriptions are to be regarded as illustrative in nature, and not as restrictive.

What is claimed is:

1. A device, comprising:
an antenna tuned to receive radiated energy within a frequency range of approximately 1 MHz to approximately 3 GHz;
a broadband amplifier circuit electrically connected to said antenna;
a battery electrically connected to said broadband amplifier circuit;
an LED indicator lamp electrically connected to said broadband amplifier circuit; and
a substantially tubular watertight PVC enclosure enclosing said antenna, said power source, said broadband amplifier circuit, and said indicator lamp.

2. A device, comprising:
an antenna tuned to receive radiated energy within a frequency range of approximately 1 MHz to approximately 3 GHz;
a broadband amplifier circuit electrically coupled to said antenna;
a power source electrically connected to said broadband amplifier circuit;
an indicator lamp electrically connected to said broadband amplifier circuit; and
a substantially tubular watertight enclosure enclosing said antenna, said power source, and said broadband amplifier circuit.

3. A device, comprising:
an antenna tuned to receive radiated energy within a frequency range of approximately 1 MHz to approximately 3 GHz;
a broadband amplifier circuit electrically coupled to said antenna;
a power source electrically connected to said broadband amplifier circuit; and
an indicator electrically connected to said broadband amplifier circuit.

4. The device of claim 3, further comprising a watertight enclosure surrounding said antenna, said power source, and said broadband amplifier circuit.

5. The device of claim 3, further comprising a watertight PVC enclosure surrounding said antenna, said power source, and said broadband amplifier circuit.

6. The device of claim 3, further comprising a watertight enclosure enclosing said antenna, said power source, said indicator, and said broadband amplifier circuit.

7. The device of claim 3, further comprising a watertight enclosure enclosing said antenna, said power source, and said broadband amplifier circuit, wherein said watertight enclosure includes a clear epoxy resin.

8. The device of claim 3, further comprising a watertight enclosure enclosing said antenna, said power source, and said broadband amplifier circuit, wherein said watertight enclosure includes a clear epoxy resin substantially surrounding said indicator, said epoxy resin, in an operative configuration, diffusing an illumination of said indicator to give a wider visibility of said indicator to a viewer.

9. The device of claim 3, wherein said indicator is an indicator lamp.

10. The device of claim 3, wherein said indicator is an LED.

11. The device of claim 3, wherein, in an operative configuration, said indicator lamp illuminates when at least 225 millivolts is received across said antenna.

12. A method for detecting radiated energy, comprising:
receiving, from a radiating device, radiated energy within a frequency range of approximately 1 MHz to approximately 3 GHz at a detection device having an antenna electrically connected to a powered broadband amplifier circuit that is electrically connected to an illuminable indicator, the antenna, circuit, and indicator contained in a watertight enclosure; and
illuminating the illuminable indicator if a voltage created across the antenna by the received radiated energy is above a predetermined amount.

13. The method of claim 12, wherein the predetermined amount is at least 50 millivolts.

14. The method of claim 12, wherein the predetermined amount is at least 100 millivolts.

15. The method of claim 12, wherein the predetermined amount is at least 200 millivolts.

16. The method of claim 12, wherein the predetermined amount is at least 400 millivolts.

17. The method of claim 12, wherein the predetermined amount is at least 500 millivolts.

18. The method of claim 12, wherein the predetermined amount is chosen from a range of approximately 50 millivolts to approximately 500 millivolts.

19. The method of claim 12, further comprising:
increasing a distance between the radiating device and the detection device until the illuminable indicator extinguishes.

20. The method of claim 12, further comprising:
correlating a distance between the radiating device and the detection device to an effective radiated power.

21. The method of claim 12, wherein the radiating device is a transmission line.

22. The method of claim 12, wherein the radiating device is a radiating antenna.

23. The method of claim 12, wherein the radiating device is a microwave oven.

24. The method of claim 12, wherein the radiating device is an electric fence.

25. The method of claim 12, wherein the radiating device is a spark plug.

26. A device comprising a broadband radiated RF energy detector.

27. A system, comprising:
means for receiving, from a radiating device, radiated energy within a frequency range of approximately 1 MHz to approximately 3 GHz at a detection device having an antenna electrically connected to a powered broadband amplifier circuit that is electrically connected to an illuminable indicator, the antenna, circuit, and indicator contained in a watertight enclosure; and
means for illuminating the illuminable indicator if a voltage created across the antenna by the received radiated energy is above a predetermined amount.
